(19) United States
(12) Patent Application Publication
(10) Pub. No.: US 2026/0188645 A1
(43) Pub. Date: Jul. 2, 2026

(54) NON-AQUEOUS ELECTROLYTE SECONDARY BATTERY

(71) Applicant: Panasonic Energy Co., Ltd., Moriguchi-shi, Osaka (JP)

(72) Inventors: Keiichi Hamanaka, Osaka (JP); Takayuki Nakatsutsumi, Osaka (JP)

(73) Assignee: Panasonic Energy Co., Ltd., Moriguchi-shi, Osaka (JP)

(21) Appl. No.: 19/130,714

(22) PCT Filed: Nov. 24, 2023
(86) PCT No.: PCT/JP2023/042174

§ 371 Date: May 16, 2025

(30) Foreign Application Priority Data
Nov. 30, 2022 (JP) 2022-192083

(51) Int. Cl. H01M 4/133; H01M 4/02; H01M 4/36; H01M 4/38; H01M 10/0525; H01M 10/0587

(52) U.S. Cl. CPC H01M 4/133; H01M 4/364; H01M 4/386; H01M 10/0525; H01M 10/0587; H01M 2004/021; H01M 2004/027

(57) ABSTRACT

The negative electrode includes a negative electrode core and a negative electrode mixture layer. The negative electrode mixture layer includes graphite particles A that have an internal porosity of 5% or less and graphite particles B that have an internal porosity of 8-20%. When the negative electrode is divided in the length direction into a first region extending from the winding inner end of the negative electrode to 80% and a second region extending from the winding outer end of the first region to the winding outer end of the negative electrode, the ratio C1 of the mass of the graphite particles A to the mass of the graphite particles B in the first region and the ratio of the mass of the graphite particles A to the mass of the graphite particles B in the second region satisfying the relationship C1>C2.

### TECHNICAL FIELD

The present disclosure relates to a non-aqueous electrolyte secondary battery.

### BACKGROUND ART

Non-aqueous electrolyte secondary batteries such as lithium-ion batteries using a carbon material such as graphite as a negative electrode active material have been widely used. Patent Literature 1 discloses a non-aqueous electrolyte secondary battery in which a carbon material A having an internal porosity of greater than or equal to 1% and less than 23% and a carbon material B having an internal porosity of greater than or equal to 23% and less than or equal to 40% are mixed to be use as a carbon material.

### CITATION LIST

### Patent Literature

PATENT LITERATURE 1: Japanese Unexamined Patent Application Publication No. 2014-67638

### SUMMARY

In a non-aqueous electrolyte secondary battery using an electrode assembly in which a positive electrode and a negative electrode are wound via a separator, repeating charge and discharge of the battery increases a pressure load to the electrode plates due to expansion and contraction of a negative electrode mixture layer. This may cause damage of the electrode plates such as elongation and breakage. In particular, expansion and contraction of the negative electrode mixture layer during charge and discharge become large with recent increased capacity of the non-aqueous electrolyte secondary battery, and the damage of the electrode plates has become more considerable.

It is an advantage of the present disclosure to provide a non-aqueous electrolyte secondary battery that inhibits the damage of the electrode plates due to expansion and contraction of the negative electrode mixture layer and that has excellent reliability.

A non-aqueous electrolyte secondary battery according to the present disclosure comprises: an electrode assembly in which a positive electrode and a negative electrode are wound via a separator; a non-aqueous electrolyte; and an exterior housing can that houses the electrode assembly and the non-aqueous electrolyte. The negative electrode includes a negative electrode core and a negative electrode mixture layer disposed on a surface of the negative electrode core, the negative electrode mixture layer includes graphite particles A having an internal porosity of less than or equal to 5% and graphite particles B having an internal porosity of greater than or equal to 8% and less than or equal to 20%, as a negative electrode active material, and in a longitudinal direction of the negative electrode, when the negative electrode is divided into: a first region from an inside end of winding of the negative electrode to 80% of a length of the negative electrode; and a second region from an outside end of winding of the first region to an outside end of winding of the negative electrode, a proportion C1 of a mass of the graphite particles A relative to a mass of the graphite particles B in the first region and a proportion C2 of a mass of the graphite particles A relative to a mass of the graphite particles B in the second region satisfy C1>C2.

The non-aqueous electrolyte secondary battery according to the present disclosure may inhibit the damage of the electrode plates due to expansion and contraction of the negative electrode mixture layer.

### BRIEF DESCRIPTION OF DRAWING

FIG. 1 is an axial sectional view of a non-aqueous electrolyte secondary battery of an example of an embodiment.

FIG. 2 is a front view illustrating a negative electrode of an example of an embodiment.

FIG. 3 is a schematic view illustrating a cross section of a graphite particle of an example of an embodiment.

### DESCRIPTION OF EMBODIMENTS

As noted above, in the non-aqueous electrolyte secondary battery, repeating charge and discharge of the battery increases the pressure load to the electrode plates due to expansion and contraction of the negative electrode mixture layer, and may cause the damage of the electrode plates such as elongation and breakage. In particular, if the electrode plates are damaged, short circuit and the like tend to occur on an end of winding of the negative electrode (an outside end of winding) disposed on an outer peripheral portion of the non-aqueous electrolyte secondary battery, and reliability of the non-aqueous electrolyte secondary battery may considerably deteriorate.

The present inventors have intensively investigated the above problem, and consequently found that a non-aqueous electrolyte secondary battery having excellent reliability can be provided by decreasing a proportion of graphite particles A having a small internal porosity and by increasing a proportion of graphite particles B having a large internal porosity in a negative electrode mixture layer formed on an outside end of winding of a negative electrode among negative electrode mixture layers. This is presumably because increasing the proportion of the graphite particles B having the large internal porosity increases a porosity of the negative electrode mixture layer formed on the outside end of winding to inhibit increase in pressure inside the battery due to expansion and contraction of the negative electrode mixture layer, resulting in reduction in the pressure load to the electrode plates.

Hereinafter, an example of an embodiment of a cylindrical non-aqueous electrolyte secondary battery according to the present disclosure will be described in detail with reference to the drawings. The embodiments described below are merely an example, and the present disclosure is not limited to the following embodiments. Aspects composed of selective combinations of constituents in the embodiments described below are included in the present disclosure.

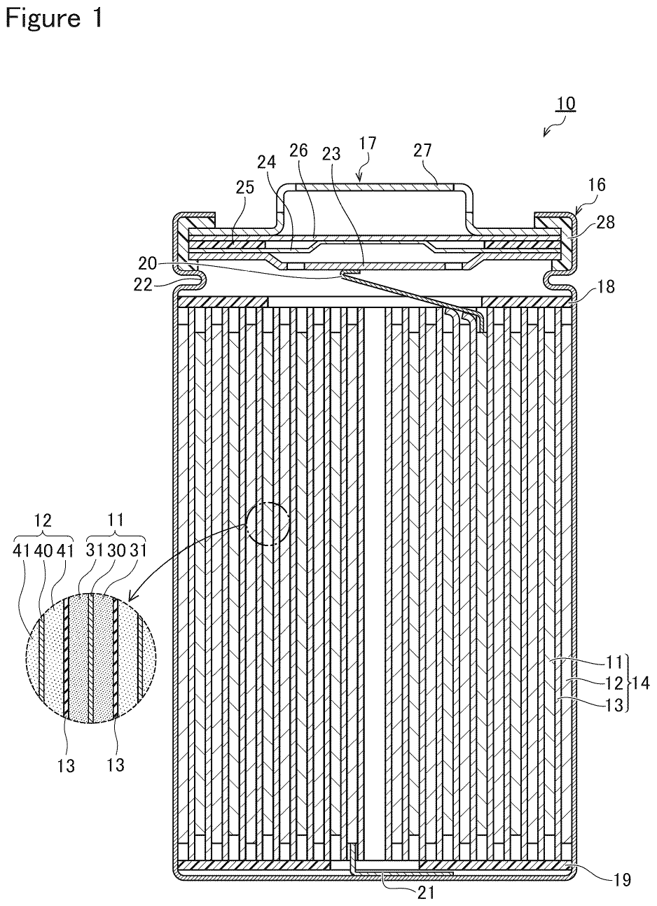

FIG. 1 is a view schematically illustrating a cross section of a non-aqueous electrolyte secondary battery (hereinafter, simply referred to as the battery) 10 of an example of an embodiment. As illustrated in FIG. 1, the battery 10 comprises a wound electrode assembly 14, a non-aqueous electrolyte (not illustrated), and an exterior housing can 16 housing the electrode assembly 14 and the non-aqueous electrolyte. The electrode assembly 14 has a positive electrode 11, a negative electrode 12, and a separator 13, and has a wound structure in which the positive electrode 11 and the negative electrode 12 are spirally wound via the separator 13. The exterior housing can 16 is a bottomed cylindrical metallic container having an opening portion at one side in an axial direction, and the opening portion of the exterior housing can 16 is sealed with a sealing assembly 17. Note that, in FIG. 1, a number of winding is illustrated to be smaller than an actual number of winding in order to clarify the positional relationship of the positive electrode 11, the negative electrode 12, and the separator 13 in the electrode assembly 14. Hereinafter, the sealing assembly 17 side in the axial direction (a height direction) of the battery 10 will be described as “the upper side”, and the bottom side of the exterior housing can 16 in the axial direction will be described as “the lower side”.

The non-aqueous electrolyte has ion conductivity (for example, lithium-ion conductivity). The non-aqueous electrolyte may be a liquid electrolyte (an electrolyte liquid) or may be a solid electrolyte.

The liquid electrolyte (the electrolyte liquid) includes a non-aqueous solvent and an electrolyte salt dissolved in the non-aqueous solvent. For the non-aqueous solvent, esters, ethers, nitriles, amides, and a mixed solvent of greater than or equal to two thereof, and the like are used, for example. An example of the non-aqueous solvent is ethylene carbonate (EC), ethyl methyl carbonate (EMC), dimethyl carbonate (DMC), diethyl carbonate (DEC), a mixed solvent thereof, or the like. The non-aqueous solvent may contain a halogen-substituted derivative in which hydrogen of these solvents is at least partially replaced with a halogen atom such as fluorine (for example, fluoroethylene carbonate or the like). For the electrolyte salt, a lithium salt such as LiPF₆ is used, for example.

As the solid electrolyte, a solid or gel polymer electrolyte, an inorganic solid electrolyte, and the like are used, for example. The polymer electrolyte includes a lithium salt and a matrix polymer, or includes the non-aqueous solvent, the lithium salt, and a matrix polymer, for example. As the matrix polymer, a polymer material that absorbs the non-aqueous solvent to gel is used, for example. As the polymer, a fluororesin, an acrylic resin, a polyether resin, and the like are used, for example. For the inorganic solid electrolyte, a known material for an all-solid lithium-ion secondary battery or the like (for example, an oxide-type solid electrolyte, a sulfide-type solid electrolyte, a halogen-type solid electrolyte, and the like) is used, for example.

The positive electrode 11, the negative electrode 12, and the separator 13, which constitute the electrode assembly 14, are all a band-shaped elongated body, and spirally wound to be alternately stacked in a radial direction of the electrode assembly 14. To prevent precipitation of lithium, the negative electrode 12 is formed to be one size larger than the positive electrode 11. That is, the negative electrode 12 is formed to be longer than the positive electrode 11 in a longitudinal direction and a width direction. The separators 13 are formed to be one size larger than at least the positive electrode 11, and two of them are disposed so as to sandwich the positive electrode 11, for example. The electrode assembly 14 has a positive electrode lead 20 connected to the positive electrode 11 by welding or the like, and a negative electrode lead 21 connected to the negative electrode 12 by welding or the like.

Insulating plates 18 and 19 are respectively disposed on the upper and lower sides of the electrode assembly 14. In the example illustrated in FIG. 1, the positive electrode lead 20 extends through a through hole of the insulating plate 18 toward the sealing assembly 17 side, and the negative electrode lead 21 extends through the outside of the insulating plate 19 toward the bottom side of the exterior housing can 16. The positive electrode lead 20 is connected to a lower surface of an internal terminal plate 23 of the sealing assembly 17 by welding or the like, and a cap 27, which is a top plate of the sealing assembly 17 electrically connected to the internal terminal plate 23, becomes a positive electrode terminal. The negative electrode lead 21 is connected to a bottom inner surface of the exterior housing can 16 by welding or the like, and the exterior housing can 16 becomes a negative electrode terminal.

A gasket 28 is provided between the exterior housing can 16 and the sealing assembly 17 to achieve sealability inside the battery. On the exterior housing can 16, a grooved portion 22 in which a part of a side wall thereof projects inward to support the sealing assembly 17 is formed. The grooved portion 22 is preferably formed in a circular shape along a circumferential direction of the exterior housing can 16, and supports the sealing assembly 17 with the upper face thereof. The sealing assembly 17 is fixed on the upper part of the exterior housing can 16 with the grooved portion 22 and with an end part of the opening portion of the exterior housing can 16 caulked to the sealing assembly 17.

The sealing assembly 17 has a stacked structure of the internal terminal plate 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected at each of central parts thereof, and the insulating member 25 is interposed between the circumferential parts of the lower vent member 24 and the upper vent member 26. If the internal pressure of the battery increases due to abnormal heat generation, the lower vent member 24 is deformed so as to push the upper vent member 26 up toward the cap 27 side and breaks, and thereby a current pathway between the lower vent member 24 and the upper vent member 26 is cut off. If the internal pressure further increases, the upper vent member 26 breaks, and gas is discharged through an opening portion of the cap 27.

Hereinafter, the positive electrode 11, the negative electrode 12, and the separator 13, which constitute the electrode assembly 14, specifically the negative electrode 12, will be described in detail.

### [Negative Electrode]

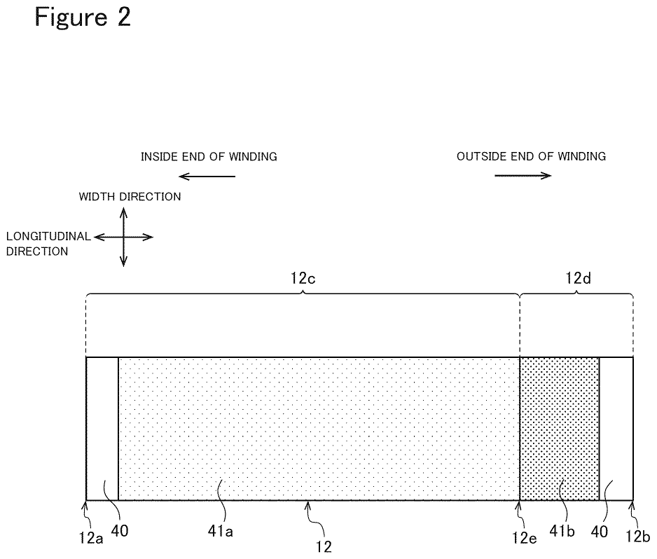

FIG. 2 is a front view of the negative electrode 12 of an example of an embodiment. As illustrated in FIG. 2, the negative electrode 12 has a negative electrode core 40 and a negative electrode mixture layer 41 formed on a surface of the negative electrode core 40. The negative electrode core 40 is exposed near an inside end of winding 12a and near an outside end of winding 12b of the negative electrode 12. The negative electrode lead 21 (see FIG. 1) is connected to the exposed portion of the negative electrode core 40 on the inside end of winding, and the exposed portion of the negative electrode core 40 on the outside end of winding is contacted with an inner surface of the exterior housing can 16 (see FIG. 1).

For the negative electrode core 40, a foil of a metal stable within a potential range of the negative electrode, such as copper, a film in which such a metal is disposed on a surface layer thereof, and the like are used, for example. A thickness of the negative electrode core 40 is, for example, greater than or equal to 5 μm and less than or equal to 30 μm.

The negative electrode mixture layer 41 has a first negative electrode mixture layer 41a formed on the inside end of winding of the negative electrode 12 and a second negative electrode mixture layer 41b formed on the outside end of winding of the negative electrode 12. Specifically, in the longitudinal direction of the negative electrode 12, the negative electrode 12 is divided into: a first region 12c from the inside end of winding 12a toward the outside end of winding to 80% of a length of the negative electrode 12; and a second region 12d from an outside end of winding 12e of the first region to an outside end of winding 12b. In this case, the negative electrode mixture layer 41 provided in the first region 12c is defined as the first negative electrode mixture layer 41a, and the negative electrode mixture layer 41 provided in the second region 12d is defined as the second negative electrode mixture layer 41b.

An average basis weight of the second negative electrode mixture layer 41b is preferably less than or equal to 90%, and more preferably less than or equal to 80% of an average basis weight of the first negative electrode mixture layer 41a. According to this, the increase in pressure inside the battery due to expansion and contraction of the negative electrode mixture layer 41 is inhibited even with repeated charge and discharge, leading to reduction in the pressure load to the negative electrode 12 plate. As a result, the damage of the electrode plate of the negative electrode 12 is inhibited to improve reliability of the battery 10.

The average basis weight of the second negative electrode mixture layer 41b is preferably greater than or equal to 50%, and more preferably greater than or equal to 60% of the average basis weight of the first negative electrode mixture layer 41a. According to this, decrease in the capacity of the battery 10 is inhibited. Thus, an example of a preferable range of the average basis weight of the second negative electrode mixture layer 41b is greater than or equal to 50% and less than or equal to 90%, and more preferably greater than or equal to 60% and less than or equal to 80% of the average basis weight of the first negative electrode mixture layer 41a. A thickness of the second negative electrode mixture layer 41b is, for example, greater than or equal to 10 μm and less than or equal to 150 μm on one side of the negative electrode core 40.

The negative electrode mixture layer 41 includes graphite particles A having an internal porosity of less than or equal to 5% and graphite particles B having an internal porosity of greater than or equal to 8% and less than or equal to 200%, as the negative electrode active material. Although a detail will be described later, the internal porosity of the graphite particles is a two-dimensional value determined from a ratio of an area of internal pores of the graphite particles relative to a cross-sectional area of the graphite particles.

The graphite particles A and the graphite particles B are not particularly limited to natural graphite, artificial graphite, and the like, but the graphite particles B are preferably natural graphite. Use of natural graphite as the graphite particles B inhibits increase in pressure inside the battery due to expansion and contraction of the negative electrode mixture layer 41 even with repeated charge and discharge to reduce the pressure load to the negative electrode 12 plate, leading to improvement of reliability of the battery 10.

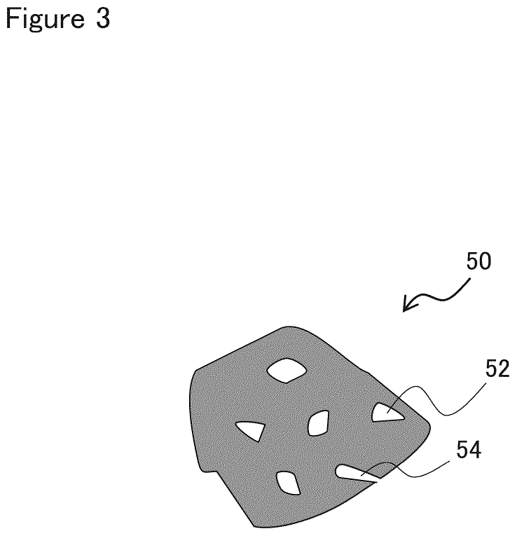

A method for measuring the internal porosity of the graphite particles will be described with reference to FIG. 3. FIG. 3 is a sectional view of a graphite particle 50 included in the negative electrode mixture layer 41. The graphite particle 50 has, in cross-sectional view of the graphite particle 50, pores 52 that are not connected from the inside of the particles to the particle surface and that are closed (hereinafter, internal pores 52), and pores 54 that are connected from the inside of the particles to the particle surface (hereinafter, external pores 54). The internal porosity of the graphite particle 50 is determined in the following procedure.

### <Method for Measuring Internal Porosity>

(1) A cross section of the negative electrode active material layer is exposed. Examples of the method for exposing the cross section include a method of cutting a part of the negative electrode 12 and processing the negative electrode 12 with an ion-milling apparatus (for example, IM4000PLUS, manufactured by Hitachi High-Tech Corporation) to expose the cross section of the negative electrode active material layer.

(2) By using a scanning electron microscope, a backscattered electron image of the exposed cross section of the negative electrode active material layer is photographed. The magnification with photographing the backscattered electron image is greater than or equal to 3000 and less than or equal to 5000.

(3) The sectional image obtained as above is imported into a computer, and subjected to a binarization processing by using an image analysis software (for example, ImageJ, available from National Institutes of Health). A binarization-processed image is obtained in which the particle cross section in the sectional image is converted in black and pores present in the particle cross section are converted in white.

(4) From the binarization-processed image, graphite particles A and graphite particles B having a particle diameter of greater than or equal to 5 μm and less than or equal to 50 μm are selected, and an area of the cross section of the graphite particle and an area of the internal pores present on the cross section of the graphite particle is calculated. Here, the area of the cross section of the graphite particle refers to an area of a region surrounded by outer periphery of the graphite particle, namely an area of all the cross-sectional portions of the graphite particle. Since it may be difficult to determine whether pores having a width of less than or equal to 3 μm are the internal pores or the external pores among the pores present on the cross section of the graphite particle on the image analysis, the pores having a width of less than or equal to 3 μm may be regarded as the internal pores. From the calculated area of the cross section of the graphite particle and the area of the internal pores on the cross section of the graphite particle, the internal porosity of the graphite particle (the area of the internal pores of the cross section of the graphite particle×100/the area of the cross section of the graphite particle) is calculated. The internal porosities of the graphite particles A and the graphite particles B are each an average value of ten of the graphite particles A and the graphite particles B.

The graphite particles A and the graphite particles B are manufactured as follows, for example.

### <Graphite Particles A>

For example, cokes (precursor) being a main raw material is crushed into a predetermined size, the crushed product is aggregated with a binder, and the product is calcined in this state at a temperature of greater than or equal to 2600° C. for graphitization, and then sieved to obtain the graphite particles B having a desired size. Here, the internal porosity may be regulated to be less than or equal to 5% by a particle diameter of the precursor after crushing, a particle diameter of the precursor in the aggregated state, and the like. D50 of the precursor after crushing is preferably within a range of greater than or equal to 12 μm and less than or equal to 20 μm. When the internal porosity is reduced to a range of less than or equal to 5%, the particle diameter of the precursor after crushing is preferably set to be large.

### <Graphite Particles B>

For example, cokes (precursor) being a main raw material is crushed into a predetermined size, the crushed product is aggregated with a binder, and then calcined at a temperature of greater than or equal to 2600° C. for graphitization in a state of pressurizing molding into a block shape. The graphitized block-shaped molded product is crushed and sieved to obtain the graphite particles A having a desired size. Here, the internal porosity may be regulated to be greater than or equal to 8% and less than or equal to 20% by an amount of a volatile component added into the block-shaped molded product. D50 of the precursor after crushing is preferably within a range of greater than or equal to 12 μm and less than or equal to 20 μm. When a part of the binder added into the cokes (precursor) is evaporated during the calcining, the binder may be used as the volatile component. Examples of such a binder include pitch.

A spacing of a (002) face (d₀₀₂) of the graphite particles 50 determined by an X-ray wide-angle diffraction method is preferably, for example, greater than or equal to 0.3354 nm, more preferably greater than or equal to 0.3357 nm, preferably less than 0.340 nm, and more preferably less than or equal to 0.338 nm. A crystallite size (Lc(002)) of the graphite particles 50 determined by an X-ray diffraction method is preferably, for example, greater than or equal to 5 nm, more preferably greater than or equal to 10 mu, preferably less than or equal to 300 nm, and more preferably less than or equal to 200 nm. The spacing (d₀₀₂) and the crystallite size (Lc(002)) satisfying the above ranges tend to increase the battery capacity compared with a case of not satisfying the above ranges.

A proportion C1 of a mass of the graphite particles A relative to a mass of the graphite particles B in the first region 12c and a proportion C2 of a mass of the graphite particles A relative to a mass of the graphite particles B in the second region 12d satisfy C1>C2. This relationship may set the porosity of the negative electrode active material in the second region 12d to be larger than the porosity of the negative electrode active material in the first region 12c. As a result, the increase in pressure inside the battery due to expansion and contraction of the negative electrode mixture layer 41 on the outside end of winding is inhibited even with repeated charge and discharge, leading to reduction in the pressure load to the negative electrode 12 plate, and reliability of the battery 10 is improved.

C2 preferably satisfies 25 mass %≤C1≤100 mass %, and preferably satisfies 0 mass %≤C2≤80 mass %. C2 within the above range remarkably improves reliability of the battery 10. Cl satisfies, for example, 60 mass %≤C1≤100 mass %.

In the present embodiment, when the negative electrode mixture layer 41 is bisected in a thickness direction, the graphite particles A are included at a larger amount in a half region on a side of an outer surface than in a half region on a side of the negative electrode core 40, and the graphite particles B are included at a larger amount in the half region on the side of the negative electrode core 40 than in the half region on the side of the negative electrode core. That is, the porosity of the negative electrode active material in the half region on the side of the negative electrode core 40 is larger than the porosity of the negative electrode active material in the half region on the side of the outer surface. This reduces the pressure load to the negative electrode 12 plate even with repeated charge and discharge to improve reliability of the battery 10. Note that the phrase “the negative electrode mixture layer 41 is bisected in a thickness direction” means that, when a stacking direction of the negative electrode core 40 and the negative electrode mixture layer 41 is defined as the thickness direction of the negative electrode mixture layer 41, the negative electrode mixture layer 41 is divided into half at the middle of the thickness of the negative electrode mixture layer 41.

The negative electrode active material may further include a metal that forms an alloy with lithium, such as Si and Sn, an alloy including such a metal, an oxide, and the like. Since these materials may occlude a large amount of lithium ions compared with graphite, the capacity of the battery may be increased.

The negative electrode active material preferably includes a Si-based material. Examples of the Si-based material may include: Si; an alloy including Si; a Si oxide represented by SiOₓ (0.5≤x≤1.6); a Si-containing material in which Si fine particles are dispersed in a lithium silicate phase represented by Li_{2y}SiO_{(2+y)} (0<y<2); and a Si-containing material in which Si fine particles are dispersed in a carbon phase.

From the viewpoints of increase in the capacity of the battery, inhibition of deterioration of charge-discharge cycle characteristics, and the like, a content rate in mass of the Si-based material relative to a total mass of the negative electrode active material in the negative electrode mixture layer 41 is preferably greater than or equal to 3 mass %, more preferably greater than or equal to 5 mass %, and further preferably greater than or equal to 8 mass %. In typical, increase in the content rate of the Si-based material relative to the total mass of the negative electrode active material increases expansion and contraction of the negative electrode mixture layer 41 with charge and discharge. Thus, when the negative electrode active material includes the Si-based material, the effect of the present disclosure becomes remarkable.

The negative electrode mixture layer 41 may contain a conductive agent. Examples of the conductive agent include carbon black (CB), carbon nanotube (CNT), acetylene black (AB), and Ketjenblack. These may be used singly, or in combination of greater than or equal to two thereof.

The negative electrode mixture layer 41 may further include a binder. Examples of the binder include a fluororesin, a polyimide resin, an acrylic resin, a polyolefin resin, polyacrylonitrile (PAN), styrene-butadiene rubber (SBR), nitrile-butadiene rubber (NBR), carboxymethylcellulose (CMC) or a salt thereof, polyacrylic acid (PAA) or a salt thereof (which may be PAA-Na, PAA-K, and the like, or a partially neutralized salt), and polyvinyl alcohol (PVA). These may be used singly, or in combination of greater than or equal to two thereof.

Next, a method for forming the first negative electrode mixture layer 41a and the second negative electrode mixture layer 41b will be described. For example, a negative electrode active material including the graphite particles A and the graphite particles B, the binder, and a solvent such as water are firstly mixed to prepare a first negative electrode mixture slurry. Separately, a negative electrode active material with an increased proportion of the graphite particles A compared with the negative electrode active material in the first negative electrode mixture slurry, the binder, and a solvent such as water are mixed to prepare a second negative electrode mixture slurry. The first negative electrode mixture slurry is applied onto both surfaces of the negative electrode core 40, dried, and then, on the coating film of the first negative electrode mixture slurry, the second negative electrode mixture slurry is applied onto both the surfaces, and dried. In this time, an amount of the applied second negative electrode mixture slurry on the outside end of winding of the negative electrode 12 is set to be smaller than an amount of the applied second negative electrode mixture slurry on the inside end of winding of the negative electrode 12. Then, the coating film is rolled with a roller to form the negative electrode. In the above method, the first negative electrode mixture slurry is applied and dried, and then the second negative electrode mixture slurry is applied. However, the second negative electrode mixture slurry may be applied after the first negative electrode mixture slurry is applied and before dried. Alternatively, the first negative electrode mixture slurry may be applied, dried, and rolled, and then the second negative electrode mixture slurry may be applied onto the first negative electrode mixture layer.

According to the above production method, the negative electrode mixture layer using the second negative electrode mixture slurry with a large proportion of the graphite particles A is formed on the surface of the first negative electrode mixture layer more thickly than on the surface of the second negative electrode mixture layer. This allows the first negative electrode mixture layer 41a to have a larger proportion of the graphite particles A relative to the graphite particles B than in the second negative electrode mixture layer 41b. When the negative electrode mixture layer 41 is bisected in the thickness direction, the graphite particles A are included at a larger amount in the half region on the side of the outer surface than in the half region on the side of the negative electrode core 40, and the graphite particles B are included at a larger amount in the half region on the side of the negative electrode core 40 than in the half region on the side of the outer surface.

### [Positive Electrode]

The positive electrode 11 is composed of, for example, a positive electrode core 30 (see FIG. 1) such as metal foil and a positive electrode mixture layer 31 (see FIG. 1) formed on the positive electrode core 30. For the positive electrode core 30, a foil of a metal stable within a potential range of the positive electrode, such as aluminum, a film in which such a metal is disposed on a surface layer, or the like may be used. The positive electrode mixture layer 31 includes, for example, a positive electrode active material, a binder, a conductive agent, and the like. The positive electrode 11 may be produced by, for example, applying a positive electrode mixture slurry including the positive electrode active material, the binder, the conductive agent, and the like onto the positive electrode core 30, drying the coating to form the positive electrode mixture layer 31, and then rolling this positive electrode mixture layer 31.

In the positive electrode mixture layer 31, an average basis weight of a region facing the negative electrode 12 with the formed second negative electrode mixture layer 41b is preferably less than or equal to 90%, and more preferably less than or equal to 80% of an average basis weight of a region facing to the negative electrode 12 with the formed first negative electrode mixture layer 41a. This inhibits expansion and contraction of the positive electrode mixture layer 31 even with repeated charge and discharge to improve reliability of the battery 10. The positive electrode mixture layer 31 with the changed average basis weight may be produced in the same manner as for the above negative electrode mixture layer 41. In the positive electrode mixture layer 31, a thickness of the region facing the negative electrode 12 with the formed second negative electrode mixture layer 41b is, for example, greater than or equal to 10 μm and less than or equal to 150 μm on one side of the positive electrode core 30.

Examples of the positive electrode active material may include a lithium-transition metal oxide containing a transition metal element such as Co, Mn. and Ni. The lithium-transition metal oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, or Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly, or a plurality of types thereof may be mixed for use. In terms of increase in the capacity of the non-aqueous electrolyte secondary battery, the positive electrode active material preferably includes a lithium-nickel composite oxide such as LiₓNiO₂, LiₓCo_{y}Ni_{1-y}O₂, and LiₓNi_{1-y}M_{y}O_{z} (M; at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3).

Examples of the conductive agent include carbon-based particles such as carbon black (CB), acetylene black (AB), Ketjenblack, carbon nanotube (CNT), graphene, and graphite. These may be used singly, or may be used in combination of greater than or equal to two thereof.

Examples of the binder include a fluororesin such as polytetrafluoroethylene (PTFE) and polyvinylidene fluoride (PVdF), a polyimide resin, an acrylic resin, a polyolefin resin, and polyacrylonitrile (PAN). These may be used singly, or may be used in combination of greater than or equal to two thereof.

### [Separator]

For the separator 13, a porous sheet or the like having an ion permeation property and an insulation property is used, for example. Specific examples of the porous sheet include a fine porous thin film, a woven fabric, and a nonwoven fabric. As a material for the separator, an olefin resin such as polyethylene or polypropylene, cellulose, or the like is preferable. The separator 13 may be a stacked body having a cellulose fiber layer and a thermoplastic resin fiber layer such as an olefin resin. The separator 13 may be a multilayer separator including a polyethylene layer and a polypropylene layer, and a separator in which a material such as an aramid resin and a ceramic is applied onto a surface of the separator 13 may be used.

### EXAMPLES

Hereinafter, the present disclosure will be further described with Examples, but the present disclosure is not limited to these Examples.

### Example 1

### [Production of Positive Electrode]

As a positive electrode active material, a powdery lithium-transition metal oxide represented by LiCo_{0.979}Zr_{0.001}Mg_{0.01}Al_{0.01}O₂ was used. The above positive electrode active material at 95 parts by mass, acetylene black (AB) as a conductive agent at 2.5 parts by mass, and polyvinylidene fluoride powder as a binder at 2.5 parts by mass were mixed, and an appropriate amount of N-methyl-2-pyrrolidone (NMP) was further added to prepare a positive electrode mixture slurry. This slurry was applied onto both surfaces of a positive electrode current collector composed of aluminum foil (thickness: 15 μm) by a doctor blade method, the coating film was dried, and then the coating film was rolled with a roller to produce a positive electrode in which a positive electrode mixture layer was formed on both the surfaces of the positive electrode current collector. At a part of the positive electrode, an exposed portion where the surface of the positive electrode core was exposed was provided.

### [Production of Graphite Particles A]

Cokes was crushed until the average particle diameter (median diameter D50) was 12 μm. Pitch as a binder was added into the crushed cokes, and the cokes was aggregated until the average particle diameter (median diameter D50) was 17 μm. This aggregate was calcined at a temperature of 2800° C. for graphitization, and then sieved by using a sieve with 250 mesh to obtain graphite particles A having an average particle diameter (median diameter D50) of 23 μm.

### [Production of Graphite Particles B]

Cokes was crushed until the average particle diameter (median diameter D50) was 15 μm, and pitch as a binder was added into the crushed cokes to aggregate the cokes. An isotropic pressure was applied to this aggregate to produce a block-shaped molded product having a density of greater than or equal to 1.6 g/cm³ and less than or equal to 1.9 g/cm³. This block-shaped molded product was calcined at a temperature of 2800° C. for graphitization. Then, the graphitized block-shaped molded product was crushed, and sieved by using a sieve with 250 mesh to obtain graphite particles B having an average particle diameter (median diameter D50) of 23 μm.

### [Production of Negative Electrode]

The graphite particles B and SiO were mixed at a mass ratio of 92:8 to prepare a first negative electrode active material. 100 parts by mass of the first negative electrode active material, 1 part by mass of a sodium salt of carboxymethylcellulose (CMC-Na), and 1 part by mass of styrene-butadiene copolymer rubber (SBR) were mixed, and the mixture was kneaded in water to prepare a first negative electrode mixture slurry.

The graphite particles A and SiO were mixed at a mass ratio of 92:8 to prepare a second negative electrode active material. 100 parts by mass of the first negative electrode active material, 1 part by mass of a sodium salt of carboxymethylcellulose (CMC-Na), and 1 part by mass of styrene-butadiene copolymer rubber (SBR) were mixed, and the mixture was kneaded in water to prepare a second negative electrode mixture slurry.

The first negative electrode mixture slurry was applied onto an entirety of a negative electrode core composed of copper foil, namely on both surfaces of a first region and a second region, by a doctor blade method, and the coating film was dried to form a negative electrode mixture layer. Then, the above second negative electrode mixture slurry was applied onto the first negative electrode mixture layer, and the coating film was dried to form a negative electrode mixture layer. In this time, an mass ratio of application per unit area between the first negative electrode mixture slurry and the second negative electrode mixture slurry in the first region was set to 50:50, and an mass ratio of application per unit area between the first negative electrode mixture slurry and the second negative electrode mixture slurry in the second region was set to 56:44. The first negative electrode mixture layer and the second negative electrode mixture layer were rolled with a roller to produce a negative electrode. At a part of the negative electrode, an exposed portion where the surface of the negative electrode core was exposed was provided.

In the produced negative electrode, internal porosities of the graphite particles A and graphite particles B were measured by the above method to find 3% and 15%, respectively. A proportion C1 of a mass of the graphite particles A relative to a mass of the graphite particles B in the first region and a proportion C2 of a mass of the graphite particles A relative to a mass of the graphite particles B in the second region were respectively 1.0 and 0.8. In the produced negative electrode, a basis weight of the second negative electrode mixture layer was 90% of a basis weight of the first negative electrode mixture layer.

### [Preparation of Non-Aqueous Electrolyte]

Into a mixed solvent in which ethylene carbonate (EC), ethyl methyl carbonate (EMC), and dimethyl carbonate (DMC) were mixed at a volume ratio (25° C.) of 3:3:4, LiPF₆ was dissolved at a concentration of 1.2 mol/L to prepare a non-aqueous electrolyte.

### [Production of Non-Aqueous Electrolyte Secondary Battery]

An aluminum lead was attached to the exposed portion of the positive electrode, and a nickel lead was attached to the exposed portion of the negative electrode. The positive electrode and the negative electrode were spirally wound via a separator made of a polyolefin to produce a wound electrode assembly. Insulating plates were respectively disposed on the upper and lower sides of the above electrode assembly, and the electrode assembly was housed in an exterior housing can. The negative electrode lead was welded to a bottom of the bottomed cylindrical exterior housing can, and the positive electrode lead was welded to a sealing assembly. The electrolyte liquid was injected into the exterior housing can, and an opening portion of the exterior housing can was sealed with the sealing assembly via a gasket to produce a non-aqueous electrolyte secondary battery.

### Example 2

A non-aqueous electrolyte secondary battery was produced in the same manner as in Example 1 except that the mass ratio of application per unit area between the first negative electrode mixture slurry and the second negative electrode mixture slurry in the second region was set to 67:33. In the produced negative electrode, a proportion C1 of a mass of the graphite particles A relative to a mass of the graphite particles B in the first region and a proportion C2 of a mass of the graphite particles A relative to a mass of the graphite particles B in the second region were respectively 1.0 and 0.5. In the produced negative electrode, a basis weight of the second negative electrode mixture layer was 75% of a basis weight of the first negative electrode mixture layer.

### Example 3

A non-aqueous electrolyte secondary battery was produced in the same manner as in Example 1 except that the mass ratio of application per unit area between the first negative electrode mixture slurry and the second negative electrode mixture slurry in the second region was set to 100:0. In the produced negative electrode, a proportion C1 of a mass of the graphite particles A relative to a mass of the graphite particles B in the first region and a proportion C2 of a mass of the graphite particles A relative to a mass of the graphite particles B in the second region were respectively 1.0 and 0.1. In the produced negative electrode, a basis weight of the second negative electrode mixture layer was 50% of a basis weight of the first negative electrode mixture layer.

### Comparative Example 1

A non-aqueous electrolyte secondary battery was produced in the same manner as in Example 1 except that the mass ratio of application per unit area between the first negative electrode mixture slurry and the second negative electrode mixture slurry in the second region was set to 50:50. In the produced negative electrode, a proportion C1 of a mass of the graphite particles A relative to a mass of the graphite particles B in the first region and a proportion C2 of a mass of the graphite particles A relative to a mass of the graphite particles B in the second region were respectively 1.0 and 1.0. In the produced negative electrode, a basis weight of the second negative electrode mixture layer was 100% of a basis weight of the first negative electrode mixture layer.

### [Cycle Test]

Each of the batteries was charged at a constant current of 0.5 C until a battery voltage reached 4.2 V, and then charged at a constant voltage of 4.2 V until a charge current reached 0.05 C. Thereafter, the battery was discharged at a constant current of 0.5 C until the battery voltage reached 3.0 V. This course of charge and discharge was defined as one cycle, and the charge and discharge were performed with 100 cycles.

### [Measurement of Elongation Percentage]

At the 1st cycle and 100th cycle of the above charge and discharge, X-ray CT photographing of each battery was performed by using inspeXio SMX-255CT FPD HR, manufactured by SHIMADZU CORPORATION. From the X-ray CT image of each battery, the elongation percentage of the negative electrode after the 100 cycles was measured by using Image-Pro Analyser, which was an image analysis software manufactured by Media Cybernetics, relative to a length of the negative electrode at the 1st cycle as a reference.

Table 1 shows the elongation percentages of the negative electrodes of the batteries of Examples and Comparative Example after the 100 cycles. The elongation percentages of the negative electrodes in Table 1 are values relative to the percentage of the battery of Comparative Example 1 being 100, and a smaller value thereof means a smaller elongation percentage of the negative electrode.

TABLE 1

| | Negative electrode | | | Evaluation result |
|---|---|---|---|---|
| | Ratio of basis weight | | | Elongation percentage |
| | of second region relative | | | of negative electrode |
| | to basis weight of | C1 | C2 | after 100 cycles |
| | first region | [mass %] | [mass %] | (relative value) |
| Example1 | 90% | 1.0 | 0.8 | 89.6 |
| Example2 | 75% | 1.0 | 0.5 | 80.0 |
| Example3 | 50% | 1.0 | 0.1 | 69.6 |
| Comparative | 100% | 1.0 | 1.0 | 100 |
| Example1 | | | | |

As shown in Table 1, the batteries of Examples with C2 smaller than C1 reduced the elongation percentage of the negative electrode after the 100 cycles compared with the battery of Comparative Example with C1 equal to C2. In the batteries of Examples, a smaller ratio of the basis weight of the negative electrode mixture layer in the second region relative to the basis weight of the negative electrode mixture layer in the first region reduced the elongation percentage of the negative electrode.

From the above results, the damage of the electrode plates due to expansion and contraction of the negative electrode mixture layer with charge and discharge may be inhibited by setting the proportion C1 of the mass of the graphite particles A relative to the mass of the graphite particles B in the first region and the proportion C2 of the mass of the graphite particles A relative to the mass of the graphite particles B in the second region to satisfy C1>C2.

In the present Examples, the average basis weight of the negative electrode mixture layer in the second region was set to be smaller than the average basis weight of the negative electrode mixture layer in the first region, but the setting is not limited thereto. Even when the average basis weight of the negative electrode mixture layer in the second region is equal to the average basis weight of the negative electrode mixture layer in the first region, satisfying C1>C2 inhibits increase in pressure inside the battery due to expansion and contraction of the negative electrode mixture layer to reduce the pressure load to the electrode plates, resulting in improvement of reliability of the battery.

The present disclosure will be further described with the following embodiments.

Constitution 1: A non-aqueous electrolyte secondary battery, comprising: an electrode assembly in which a positive electrode and a negative electrode are wound via a separator: a non-aqueous electrolyte; and an exterior housing can that houses the electrode assembly and the non-aqueous electrolyte, wherein the negative electrode includes a negative electrode core and a negative electrode mixture layer disposed on a surface of the negative electrode core, the negative electrode mixture layer includes graphite particles A having an internal porosity of less than or equal to 5% and graphite particles B having an internal porosity of greater than or equal to 8% and less than or equal to 20%, as a negative electrode active material, and in a longitudinal direction of the negative electrode, when the negative electrode is divided into: a first region from an inside end of winding of the negative electrode to 80% of a length of the negative electrode; and a second region from an outside end of winding of the first region to an outside end of winding of the negative electrode, a proportion C1 of a mass of the graphite particles A relative to a mass of the graphite particles B in the first region and a proportion C2 of a mass of the graphite particles A relative to a mass of the graphite particles B in the second region satisfy C1>C2.

Constitution 2: The non-aqueous electrolyte secondary battery according to Constitution 1, wherein an average basis weight of the negative electrode mixture layer in the second region is less than or equal to 90% of an average basis weight of the negative electrode mixture layer in the first region.

Constitution 3: The non-aqueous electrolyte secondary battery according to Constitution 1 or 2, wherein when the negative electrode mixture layer is bisected in a thickness direction, the graphite particles A are included at a larger amount in a half region on a side of an outer surface than in a half region on a side of the negative electrode core, and the graphite particles B are included at a larger amount in the half region on the side of the negative electrode core than in the half region on the side of the outer surface.

Constitution 4: The non-aqueous electrolyte secondary battery according to any one of Constitutions 1 to 3, wherein the negative electrode mixture layer includes a Si-based material as the negative electrode active material.

Constitution 5: The non-aqueous electrolyte secondary battery according to Constitution 4, wherein a content rate of the Si-based material is greater than or equal to 3 mass % relative to a total mass of the negative electrode active material.

Constitution 6: The non-aqueous electrolyte secondary battery according to any one of Constitutions 1 to 5, wherein the positive electrode includes a positive electrode core and a positive electrode mixture layer disposed on a surface of the positive electrode core, and an average basis weight of the positive electrode mixture layer in a region facing the second region is less than or equal to 90% of an average basis weight of the positive electrode mixture layer in a region facing the first region.

### REFERENCE SIGNS LIST

10 Non-aqueous electrolyte secondary battery, 11 Positive electrode, 12 Negative electrode, 12a Inside end of winding, 12b Outside end of winding, 12c First region, 12d Second region. 12e Outside end of winding, 13 Separator, 14 Electrode assembly, 16 Exterior housing can. 17 Sealing assembly, 18 Insulating plate, 19 Insulating plate, 20 Positive electrode lead, 21 Negative electrode lead, 22 Grooved portion, 23 Internal terminal plate, 24 Lower vent member, 25 Insulating member, 26 Upper vent member, 27 Cap, 28 Gasket, 30 Positive electrode core, 31 Positive electrode mixture layer, 40 Negative electrode core, 41 Negative electrode mixture layer, 41a First negative electrode mixture layer, 41b Second negative electrode mixture layer, 50 Graphite particle, 52 Internal pores (Pores), 54 External pores (Pores)

1. A non-aqueous electrolyte secondary battery, comprising:
an electrode assembly in which a positive electrode and a negative electrode are wound via a separator;
a non-aqueous electrolyte; and
an exterior housing can that houses the electrode assembly and the non-aqueous electrolyte, wherein
the negative electrode includes a negative electrode core and a negative electrode mixture layer disposed on a surface of the negative electrode core,
the negative electrode mixture layer includes graphite particles A having an internal porosity of less than or equal to 5% and graphite particles B having an internal porosity of greater than or equal to 8% and less than or equal to 20%, as a negative electrode active material, and
in a longitudinal direction of the negative electrode, when the negative electrode is divided into: a first region from an inside end of winding of the negative electrode to 80% of a length of the negative electrode; and a second region from an outside end of winding of the first region to an outside end of winding of the negative electrode,
a proportion C1 of a mass of the graphite particles A relative to a mass of the graphite particles B in the first region and a proportion C2 of a mass of the graphite particles A relative to a mass of the graphite particles B in the second region satisfy C1>C2.

2. The non-aqueous electrolyte secondary battery according to claim 1, wherein an average basis weight of the negative electrode mixture layer in the second region is less than or equal to 90% of an average basis weight of the negative electrode mixture layer in the first region.

3. The non-aqueous electrolyte secondary battery according to claim 1, wherein
when the negative electrode mixture layer is bisected in a thickness direction,
the graphite particles A are included at a larger amount in a half region on a side of an outer surface than in a half region on a side of the negative electrode core, and
the graphite particles B are included at a larger amount in the half region on the side of the negative electrode core than in the half region on the side of the outer surface.

4. The non-aqueous electrolyte secondary battery according to claim 1, wherein the negative electrode mixture layer includes a Si-based material as the negative electrode active material.

5. The non-aqueous electrolyte secondary battery according to claim 4, wherein a content rate of the Si-based material is greater than or equal to 3 mass % relative to a total mass of the negative electrode active material.

6. The non-aqueous electrolyte secondary battery according to claim 1, wherein
the positive electrode includes a positive electrode core and a positive electrode mixture layer disposed on a surface of the positive electrode core, and
an average basis weight of the positive electrode mixture layer in a region facing the second region is less than or equal to 90% of an average basis weight of the positive electrode mixture layer in a region facing the first region.
